(19) United States
(12) Patent Application Publication
(10) Pub. No.: US 2010/0024018 A1
(43) Pub. Date: Jan. 28, 2010

(54) Keyboard Display Posing An Identification Challenge For An Automated Agent

(76) Inventors: Jason David Koziol, Naperville, IL (US); Anthony Ryan Koziol, Gainesville, FL (US)

Correspondence Address: MANISHA CHAKRABARTI, 3108 S. RT. 59, STE. 124-282, NAPERVILLE, IL, 60564, US

(21) Appl. No.: 12/177,825

(22) Filed: Jul. 22, 2008

(51) Int. Cl. H04L 9/32; G09G 5/00; G06F 3/048

(52) U.S. Cl. 726/7; 345/168; 715/773

(57) ABSTRACT

Methods, systems, and computer readable medium storing computer executable programs for communicating symbol data using a keyboard display that poses an identification challenge for an automated agent are disclosed. A first plurality of symbols is provided. A dynamic version of each of the first plurality of symbols is defined. The dynamic version of each of the first plurality of symbols includes a noise component. A keyboard display arrangement for displaying the dynamic version of each of the first plurality of symbols in a keyboard display is defined. A display mechanism operable to display the keyboard display including the dynamic version of the first plurality of symbols in accordance with the keyboard display arrangement is provided.

### FIELD OF THE INVENTION

The present invention generally relates to data security and more particularly to methods and systems for providing a keyboard display wherein the symbols selected from the keyboard display poses an identification challenge for an automated agent.

### BACKGROUND OF THE INVENTION

Users often use computer systems to communicate confidential and/or sensitive data to other computer systems via the Internet. Examples of such confidential and/or sensitive information include, but are not limited to, passwords, credit card numbers and social security numbers. In some cases the sensitive data is entered by a user via a hardware keyboard communicatively coupled to a user computer system. In some cases, the sensitive data is entered by a user via a virtual keyboard displayed on a user computer system display screen.

Connectivity to the Internet often exposes computers systems to malicious autonomous software applications and automated agents that seek to illegally gain access to data at such computer systems. Automated agents are typically generated by autonomous software applications that operate as an agent for a user or a program. Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents, and agents composed of sub-agents where the sub-agents themselves are individual automated agents. Keyloggers are an example of an autonomous application that illegally gains access to computer systems and monitors user keystrokes at computer systems.

### SUMMARY OF THE INVENTION

One aspect of the invention is directed to a method of communicating symbol data using a keyboard display that poses an identification challenge for an automated agent. A first plurality of symbols is provided. A dynamic version of each of the first plurality of symbols is defined. The dynamic version of each of the first plurality of symbols includes a noise component. A keyboard display arrangement for displaying the dynamic version of each of the first plurality of symbols in a keyboard display is defined. A display mechanism operable to display the keyboard display including the dynamic version of the first plurality of symbols in accordance with the keyboard display arrangement is provided.

Another aspect of the invention provides a computer readable medium for storing a computer executable program for communicating symbol data using a keyboard display that poses an identification challenge for an automated agent. The computer readable medium includes computer readable code for providing a first plurality of symbols, computer readable code for defining a dynamic version of each of the first plurality of symbols where the dynamic version of each of the first plurality of symbols includes a noise component, computer readable code for defining a keyboard display arrangement for displaying the dynamic version of each of the first plurality of symbols in a keyboard display, and computer readable code for providing a display mechanism operable to display the keyboard display including the dynamic version of the first plurality of symbols in accordance with the keyboard display arrangement.

Another aspect of the invention provides a system for communicating symbol data using a keyboard display that poses an identification challenge for an automated agent. The system includes a keyboard symbol generation module, a dynamic symbol generation module and a keyboard arrangement generation module. The keyboard symbol generation module is operable to provide a first plurality of symbols. The dynamic symbol generation module is operable to define a dynamic version of each of the first plurality of symbols. The dynamic version of each of the first plurality of symbols includes a noise component. The keyboard arrangement generation module is operable to define a keyboard display arrangement for displaying the dynamic version of each of the first plurality of symbols in a keyboard display and to provide a display mechanism operable to display the keyboard display including the dynamic version of the first plurality of symbols in accordance with the keyboard display arrangement.

### BRIEF DESCRIPTION OF THE DRAWINGS

FIG. 1 is a block diagram representation of a system that may be used to implement one embodiment of a method of communicating symbol data via a keyboard display that poses an identification challenge for an automated agent;

FIG. 2 is a block diagram representation of one embodiment of a server system;

FIG. 3 is a block diagram representation of one embodiment of a client system;

FIG. 4 is a block diagram representation of one embodiment of a keyboard communication module;

FIG. 5 is an illustrative example of an application of a scrambling application to a keyboard symbol set consisting of the letters of the alphabet by one embodiment of a keyboard arrangement generation module to generate a scrambled ordering of the symbols in the keyboard symbol set;

FIG. 6 is an illustrative example of an arrangement of the symbols in the keyboard symbol set of FIG. 5 in a keyboard display as generated by one embodiment of a keyboard arrangement generation module;

FIG. 7(a)-(f) are illustrations of a number of different symbol views of an example of a dynamic version of a symbol “1” with the application of different values of the rotation angle β while the rotation angle α is maintained at a value of 0°;

FIG. 8(a)-(e) are illustrations of a number of different symbol views of an example of a dynamic version of a symbol “1” with the application of different values of a color tone offset using a color tone function;

FIG. 9 is a flowchart representation of one embodiment of a method of communicating symbol data using a keyboard display that poses an identification challenge for an automated agent; and

FIG. 10 is a flowchart representation of one embodiment of a method of communicating symbol data using a keyboard display that poses an identification challenge for an automated agent.

### DETAILED DESCRIPTION OF THE PREFERRED EMBODIMENTS

Referring to FIG. 1, a block diagram representation of a system 100 that may be used to implement one embodiment of a method of communicating symbol data via a keyboard display that poses an identification challenge for an automated agent is shown. The system 100 generally includes a server system 102 and one or more client systems 104. The server system 102 generally defines a keyboard display using a keyboard symbol set. In one embodiment, the server system 102 selects the set of symbols used to create the keyboard symbol set.

In one embodiment, the symbols in the keyboard symbol set include alphanumeric symbols. In one embodiment, the symbols in the keyboard symbol set include images that are representative of alphanumeric symbols. For example, a letter may be represented by an object where the name of the object begins with the represented letter. For example, a symbol may be a picture of an apple where the apple is used to represent the letter A. In one embodiment, the symbols in the keyboard symbol set include non-alphanumeric symbols, such as for example, icons. Examples of icons include, but are not limited to, a happy face, star, stop sign, traffic light, speaker, eye, magnifying glass, lightning bolt, heart, checkmark and a red circle with a line through it.

The server system 102 defines a keyboard display arrangement for arranging the symbols in the keyboard symbol set within the keyboard display. In one embodiment, the keyboard display arrangement is based on a scrambled ordering of the symbols in the keyboard symbol set. In one embodiment, the scrambled ordering of the symbols in the keyboard symbol set is a randomly generated ordering.

In one embodiment, the keyboard display includes a plurality of symbol display fields. The server system 102 assigns each symbol in the keyboard symbol set to an associated symbol display field within the keyboard display. The server system 102 generates a dynamic version of each of the symbols in the keyboard symbol set. The dynamic version of each of the symbols is typically discernible by a human user while posing an identification challenge for an automated agent. The server system 102 defines a keyboard display where the dynamic version of each of the symbols in the keyboard symbol set is displayed in the associated symbol display field in accordance with the defined keyboard display arrangement. The association between each of the symbols in the keyboard symbol set and the corresponding symbol display field in the keyboard display is stored at the server system 102.

Responsive to a request received from a client system 104, the server system 102 transmits the keyboard display to the client system 104. The keyboard display including the dynamic version of each of the symbols in the keyboard symbol set is displayed in the associated symbol display field in accordance with the defined keyboard display arrangement at the client system 104. A user selects a sequence of symbols from the keyboard display at the client system 104. The sequence of symbol display fields associated with the sequence of selected symbols is transmitted from the client system 104 to the server system 102.

The sequence of symbol display fields is received at the server system 102. The server system 102 retrieves the stored association between each of the symbols in the keyboard symbol set and the corresponding symbol display fields in the keyboard display and identifies the sequence of symbols associated with the sequence of symbol display fields received from the client system 104.

In one embodiment, the server system 102 determines whether a user at a client system 104 is an authorized user responsive to a validation request received from the user at a client system 102. In one embodiment, the server system 102 grants access to protected data and/or services upon validation of the user as an authorized user. The server system 102 stores user specific sequences of symbols associated with one or more users at the server system 102. In one embodiment, a user at a client system 104 issues a validation request to the server system 102 by submitting a user identifier. Upon receiving the validation request, the server system 102 uses the received user identifier to retrieve the associated user specific sequence of symbols. In one embodiment, the user specific sequence of symbols is a user access code. Examples of user access codes include, but are not limited to a user passcode or a user password. The server system 102 generates a keyboard display using a keyboard symbol set that includes the user specific symbols and transmits the keyboard display to the client system 104.

The user enters the user access code by selecting the user specific sequence of symbols from the keyboard display at the client system 104. The sequence of symbol display fields associated with the sequence of selected symbols is transmitted from the client system 104 to the server system 102. The server system 102 retrieves the stored association between each of the symbols in the keyboard symbol set and the corresponding symbol display fields in the keyboard display and identifies the sequence of symbols associated with the sequence of symbol display fields received from the client system 104. The server system 102 compares the identified sequence of symbols against the stored user specific sequence of symbols. If the server system 102 determines that there is a match, the server system 102 validates the user at the client system 104 as an authorized user.

While the example system 100 includes a server system 102 and one or more client systems 104, alternative embodiments may include a first system, such as for example a first computer system, communicating with a second system, such as for example a second computer system.

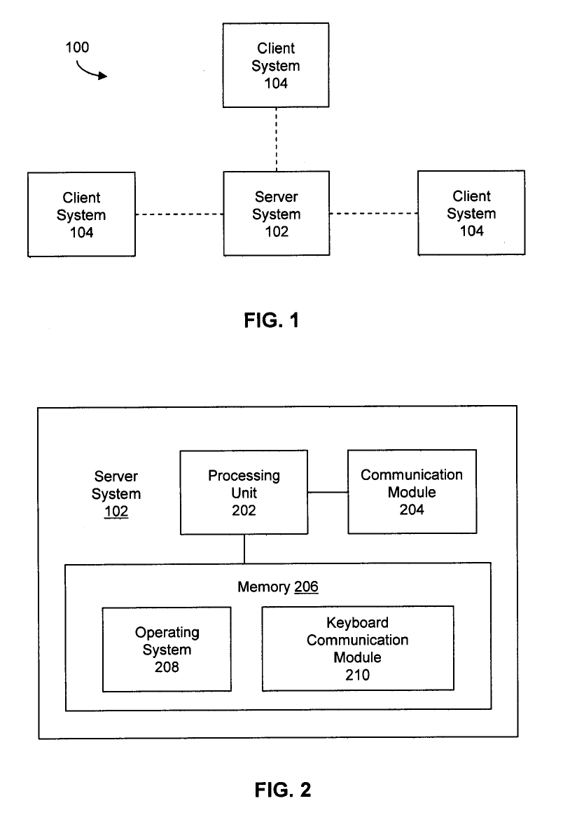

Referring to FIG. 2, a block diagram representation of one embodiment of a server system 102 is shown. The server system 102 generally includes a processing unit 202, a communication module 204, and a memory 206. The processing unit 202 generally includes a processor or controller. In one embodiment, the communication module 204 generally coordinates the exchange of data between the server system 102 and one or more client system 104. In one embodiment, the communication module 204 supports communications via a network infrastructure. In one embodiment, the communication module 204 supports communication via the Internet. In one embodiment, an operating system module 208 and a keyboard communication module 210 are stored in the memory 206. Alternative embodiments may include additional modules that facilitate the performance of symbol data communication functions.

In one embodiment, the memory 206 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. The processing unit 202 generally retrieves and executes machine readable instructions or software programs that are stored in the memory 206.

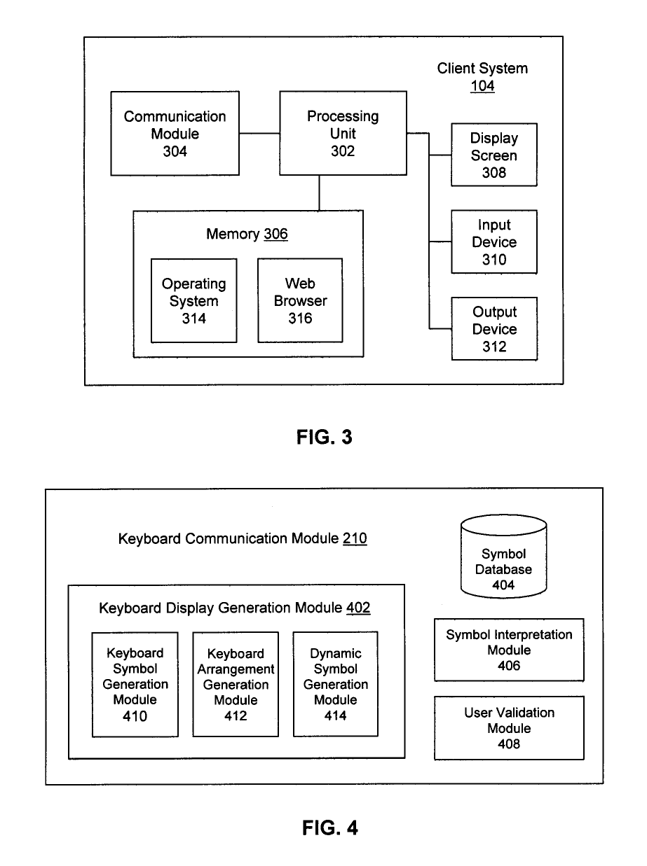

Referring to FIG. 3, a block diagram representation of one embodiment of a client system 104 is shown. The client system 102 generally includes a processing unit 302, a communication module 304, a memory 306, a display screen 308, and one or more input devices 310. In one embodiment, the client system 104 includes one or more output devices 312. In one embodiment, the display screen 308 is a touch screen display screen. In one embodiment, the input device 310 is a cursor control device, such as for example a mouse. Alternative embodiments of the client system 104 may include other input devices and/or output devices.

The processing unit 302 generally includes a processor or controller. In one embodiment, the communication module 304 supports the exchange of data between the client system 104 and the server system 102. In one embodiment, the communication module 304 supports communications via a network infrastructure. In one embodiment, the communication module 304 supports communication via the Internet. In one embodiment, an operating system module 314 is stored in the memory 306. In one embodiment, a web browser 316 is stored in the memory. Alternative embodiments may include additional modules that facilitate the performance of keyboard display based communication functions and/or other client system functions.

In one embodiment, the memory 306 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. The processing unit 302 generally retrieves and executes machine readable instructions or software programs that are stored in the memory 306.

Referring to FIG. 4, a block diagram representation of one embodiment of a keyboard communication module 210 is shown. The keyboard communication module 210 generally includes a keyboard display generation module 402, a symbol database 404, and a symbol interpretation module 406. In one embodiment, the keyboard display generation module 210 includes a user validation module 408.

The keyboard display generation module 402 generally defines the keyboard display. More specifically, the keyboard display generation module 402 generates the keyboard symbol set, defines a keyboard display arrangement for arranging the symbols in the keyboard symbol set within the keyboard display, assigns each symbol in the keyboard symbol set to an associated symbol display field within the keyboard display, and generates the dynamic version of each of the symbols in the keyboard symbol set for display in the keyboard display.

The symbol database 404 generally stores symbol related data. In one embodiment, the symbol database 404 stores the plurality of symbols available for use in the keyboard display. In one embodiment, the symbol database 404 stores the association between the symbols in the keyboard symbol set and the symbol display fields in the keyboard display for each keyboard display. In one embodiment, the symbol database 404 stores user specific sequences of symbols associated with different users.

The symbol interpretation module 406 receives the sequence of symbol display fields associated with the sequence of selected symbols selected by a user from the keyboard display at the client system 104. The symbol interpretation module 406 retrieves the stored associations between each of the symbols in the keyboard symbol set and the corresponding symbol display fields in the keyboard display and identifies the sequence of symbols associated with the sequence of symbol display fields received from the client system 104. The identified sequence of symbols represents the sequence of symbols selected by the user from the keyboard display at the client system 104.

One embodiment of the keyboard display generation module 210 includes a user validation module 408. The user validation module 408 generally determines whether a user at a client system 104 is an authorized user. The user validation module 408 receives the user identifier included in the validation request submitted by the user at the client system 104 and the sequence of symbols that have been identified by the symbol interpretation module 406 as having been selected by the user from the keyboard display at the client system 104.

The user validation module 408 retrieves the user specific sequence of symbols associated with the received user identifier from the symbol database 404. The user validation module 408 compares received sequence of symbols against the retrieved user specific sequence of symbols and determines whether there is a match. The user validation module 408 validates the user at the client system 104 as an authorized user if there is a match between the received sequence of symbols and the user specific sequence of symbols and denies validation of the user as an authorized user if the received sequence of symbols fails to match the user specific sequence of symbols.

One embodiment of the keyboard generation module 402 generally includes a keyboard symbol generation module 410, a keyboard arrangement generation module 412, and a dynamic symbol generation module 414. The keyboard symbol generation module 410 generally selects the symbols in the keyboard symbols set. The keyboard arrangement generation module 412 generally defines the keyboard display arrangement for arranging the symbols in the keyboard symbol set within the keyboard display and assigns each symbol in the keyboard symbol set to an associated symbol display field within the keyboard display. The dynamic symbol generation module 412 generally generates the dynamic version of each of the symbols in the keyboard symbol set for display in the keyboard display.

The keyboard symbol generation module 410 generates the symbols in the keyboard symbols set for use in the keyboard display. In one embodiment, the keyboard symbol generation module 410 selects a pre-defined keyboard symbol set including a pre-defined set of symbols. In one embodiment, a plurality of pre-defined keyboard symbol sets is stored in the symbol database 404. The keyboard symbol generation module 410 selects one of the pre-defined keyboard symbols sets for use with a keyboard display. In one embodiment, the keyboard symbol generation module 410 randomly selects one of the pre-defined keyboard symbols set. In one embodiment, each of the pre-defined keyboard symbols sets is defined to accommodate a specific type of keyboard symbol communication. For example, a first keyboard symbol set may include alphanumeric symbols, a second keyboard symbol set may include numeric symbols, and a third keyboard symbol set may include non-alphanumeric symbols. The keyboard symbol generation module 410 selects the keyboard symbol set based on the type of symbol data communication that the server system 102 expects to receive from the client system 104.

In one embodiment, keyboard symbol generation module 410 receives validation request including a user identifier from a user at a client system 102. The keyboard symbol generation module 410 uses the received user identifier to retrieve the user specific sequence of symbols from the symbol database 404. In one embodiment, the keyboard symbol generation module 410 retrieves an additional set of symbols from the symbol database 404. In one embodiment, the keyboard symbol selection module 408 randomly retrieves the symbols in the additional set of symbols from the available set of symbols stored in the symbol database 404. In one embodiment, the keyboard symbol generation module 410 retrieves one of several pre-defined additional symbol sets from the symbol database 404 for use in the keyboard display. The keyboard symbol set generated by the keyboard symbol generation module 410 consists of the user specific symbols in the user specific sequence of symbols and the retrieved additional set of symbols.

The keyboard arrangement generation module 412 defines the keyboard display arrangement for arranging the symbols in the keyboard symbol set within the keyboard display. The keyboard display arrangement module 412 receives the keyboard symbol set with the symbols being organized in an initial symbol order. The keyboard display arrangement module 412 generates a scrambled ordering of the symbols in the keyboard symbol set. In one embodiment, the keyboard display arrangement module 412 scrambles the initial symbol order by applying a scrambling application. In one embodiment, the keyboard display arrangement creates a randomly generated ordering of the symbols in the keyboard symbol set.

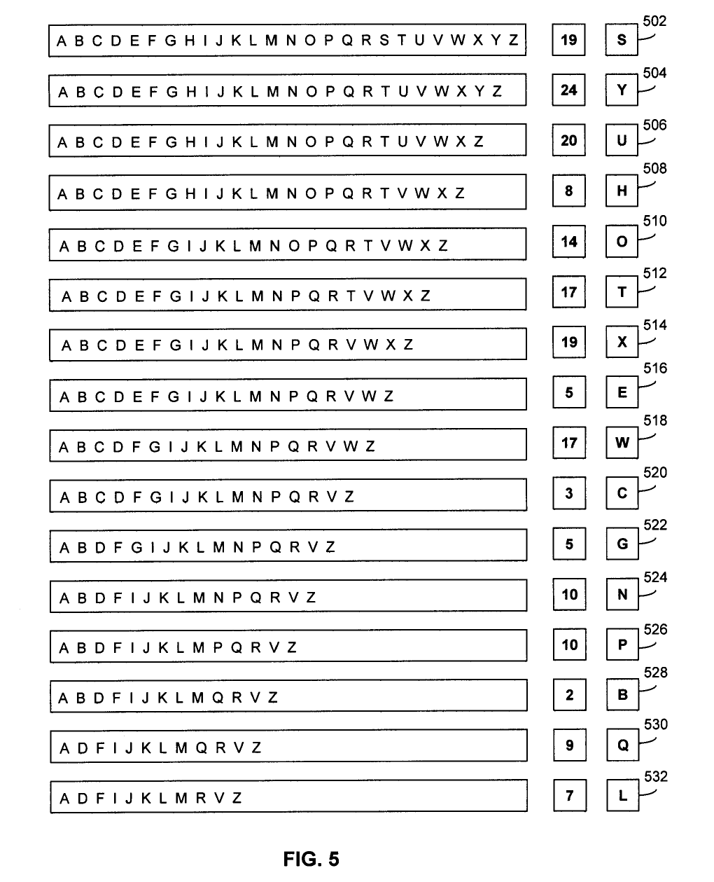

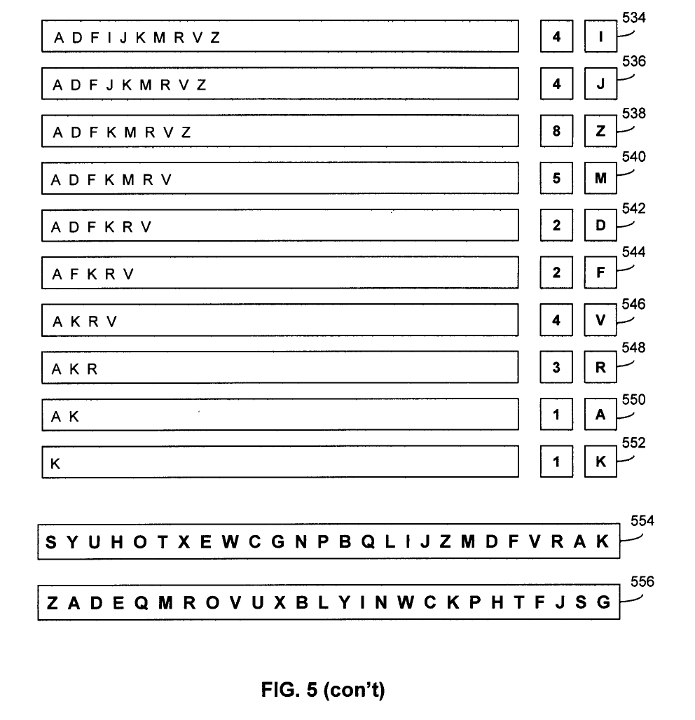

Referring to FIG. 5 an illustrative example of an application of a scrambling application to a keyboard symbol set consisting of the letters of the alphabet by one embodiment of a keyboard arrangement generation module 412 to generate a scrambled ordering of the symbols in the keyboard symbol set is shown. The keyboard display arrangement module 412 receives a keyboard symbol set with an initial symbol order 502.

The keyboard arrangement generation module 412 applies a scrambling application that applies the Equation (1) listed below to determine which letter to remove from the initial order and sequentially place in the ordered keyboard symbol set. The variable n represents the iteration.

[(floor(sin(n)×10,000))modulus(26−(n−1))]+1 Equation (1)

Referring to FIG. 5 an illustrative example of an application of a scrambling application to a keyboard symbol set consisting of the letters of the alphabet by one embodiment of a keyboard arrangement generation module 412 to generate a scrambled ordering of the symbols in the keyboard symbol set is shown. More specifically, during the the first iteration, the value of n is 1. The value of the sin (1) is 0.017452406. Multiplying the value of the sin (1) by 10,000 generates the value 174.52406. Taking the floor function of 174.52406 generates the value 174. Calculating 174 modulus (26(1−1)) generates the value 18. Adding 1 to 18 generates the value 19. During the first iteration 502, the 19^{th} letter, the letter S, is removed from the initial order and placed at the beginning of the ordered keyboard set 506. During the second iteration, the value of n is 2. Applying Equation (1) to n is equal to 2 generates a result of 24. During the second iteration 504, the 24^{th} letter, the letter Y, is removed from the sequence of letters remaining in the initial order and is placed in the second position of the ordered keyboard symbol set 554. This process is repeated 506, 508, 510, 512, 514, 516, 518, 520, 522, 524, 526, 528, 530, 532, 534, 536, 538, 540. 542, 544, 546, 548, 550, 552 until all of the letters in the initial order have been positioned in the ordered keyboard symbol set 554.

In one embodiment, the ordered keyboard set 554 is re-designated an initial order and the process repeated thereby scrambling the set 554 to generate the ordered keyboard set 556.

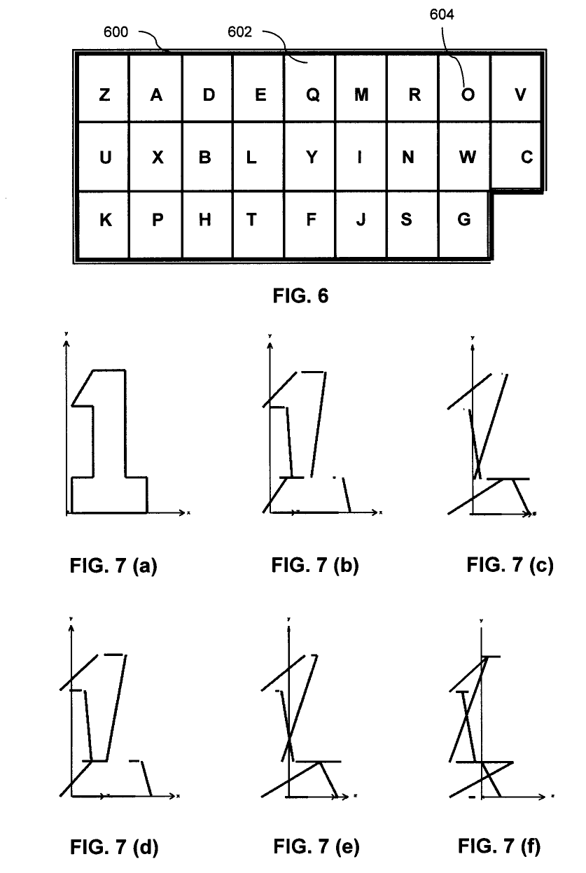

Referring to FIG. 6, an illustrative example of an arrangement of the symbols 604 in the keyboard symbol set of FIG. 5 in a keyboard display 600 as generated by one embodiment of a keyboard arrangement generation module 412 is shown. The keyboard arrangement generation module 412 has generated a keyboard display 600 including a plurality of symbol display fields 602. The number of symbol display fields 602 is equal to the number of symbols 604 in the keyboard symbol set. The keyboard arrangement generation module 412 has assigned each of the symbols 604 in a keyboard symbol set to a specific symbol display field 602 within the keyboard display in accordance with the scrambled ordering of the keyboard symbol set 556.

Referring back to FIG. 4, the dynamic symbol generation module 414 generally generates a dynamic version of each of the symbols in the keyboard symbol set. The dynamic version of the symbols in the keyboard symbol set is displayed in the keyboard display in accordance with the scrambled ordering of the keyboard symbol set. In one embodiment, the dynamic symbol generation module 414 generates a symbol image set for each symbol in the keyboard symbol set. A display mechanism displays the symbol image set for each symbol in the keyboard display in a slide show format thereby displaying a dynamic version of each of the symbols.

In one embodiment, the dynamic symbol generation module 414 generates a symbol image set for each symbol in the keyboard symbol set by generating multiple distorted versions of the symbol. The dynamic symbol generation module 414 generates a symbol image for each symbol in the keyboard symbol set and adds one or more different noise components to each of the generated symbol images thereby generating a distorted version of each of the symbols. The dynamic symbol generation module 414 generates multiple distorted versions of each symbol in the keyboard symbol set. When the keyboard display is transmitted from the server system 102 to a client system 104 for display at the client system 104, a display mechanism displays the symbol image set for each symbol in the keyboard display in a slide show format thereby displaying a dynamic version of each of the symbols. In one embodiment, the display mechanism is transmitted from the server system 102 to the client system 104.

The distorted versions of the symbols with integrated noise components are typically discernible by a human user while posing an identification challenge for an automated agent. Examples of different types of noise components that may be used include, but are not limited to various types of deformations and/or distortions of the symbol image.

In one embodiment, the dynamic symbol generation module 414 generates a symbol image set for each symbol in the keyboard symbol set that includes one or more distorted versions of each symbol and one or more non-symbol images. The non-symbol images are not recognizable as symbols. When the keyboard display is transmitted from the server system 102 to a client system 104 for display at the client system 104, a display mechanism displays the symbol image set for each symbol in the keyboard display in a slide show format thereby displaying a dynamic version of each of the symbols. In one embodiment, the display mechanism is transmitted from the server system 102 to the client system 104.

In one embodiment, the dynamic symbol generation module 414 generates a symbol image for each symbol in the keyboard symbol set and incorporates one or more dynamic noise components into each generated symbol image. Altering the value of a dynamic noise component operates to alter the view of the associated symbol. In one embodiment, the dynamic symbol generation module 414 generates an image set for each symbol. The image set for each symbol includes multiple different views of the symbol where each different view of the symbol is generated by altering the value of the dynamic noise component of the associated symbol. In one embodiment, some of the views of the symbol are discernable to a human user as the symbol while posing an identification challenge to an automated agent and some of the views of the symbol are indiscernible as the symbol to both a human user and an automated agent. When the keyboard display is transmitted from the server system 102 to a client system 104 for display at the client system 104, a display mechanism displays the symbol image set for each symbol in the keyboard display in a slide show format thereby displaying a dynamic version of each of the symbols. In one embodiment, the display mechanism is transmitted from the server system 102 to the client system 104.

In one embodiment, a display mechanism interacts with the dynamic version of each of the symbols in the keyboard display by altering the value of the dynamic noise component and displaying an updated view of the symbol in the keyboard display on a real time basis at the client system 104. In one embodiment, the display mechanism randomly alters the value of the dynamic noise components.

An example of methods and systems for generating dynamic representations or dynamic versions of a symbol including one or more dynamic noise components may be found in U.S. patent application Ser. No. 11/612,470 entitled “METHODS AND SYSTEMS FOR GENERATING A SYMBOL IDENTIFICATION CHALLENGE FOR AN AUTOMATED AGENT” listing Jason Koziol as the inventor.

For example in one disclosed method of generating a dynamic version of a symbol using a dynamic noise component, a three dimensional symbol coordinate system is defined using x, y, and z axes. A symbol image is defined the in the x-y plane. A plurality of points are selected from the symbol image defined in the x-y plane. A z-axis noise offset is added to each of the plurality of selected points thereby generating a dynamic version of the symbol. A viewing plane is generally parallel to the x-y plane of an initial orientation position of the symbol coordinate system. A symbol view is an orthogonal projection of a representation of the dynamic version of the symbol in the symbol coordinate system onto the viewing plane. The symbol view generally varies as a function of the orientation of the symbol coordinate system with respect to the viewing plane. The orthogonal projection of the representation of the dynamic version of the symbol in the symbol coordinate system, with the symbol coordinate system being in the initial orientation position, projects the symbol image onto the viewing plane.

In one embodiment, the symbol coordinate system is rotated through a rotation angle α about the x-axis. In one embodiment, the symbol coordinate system is rotated through a rotation angle β about the y-axis. In one embodiment, the symbol coordinate system is rotated through a rotation angle α about the x-axis and a rotation angle β about the y-axis. A symbol view of the dynamic version of the symbol is generated as a product of the orthogonal projection of the dynamic rendering of the symbol image in the rotated symbol coordinate system onto the viewing plane. Different symbol views can be generated by varying individual values of the rotation angle α and/or the rotation angle β. In one embodiment, the value of the rotation angle α and the value of the rotation angle β are randomly generated values. In one embodiment, the views of the symbol become increasingly similar to the symbol image as the values of the rotation angle α and the rotation angle β approach 0°.

Referring to FIG. 7(a)-(f), a number of different symbol views of an example of a dynamic version of a symbol “1” with the application of different values of the rotation angle β while the rotation angle α is maintained at a value of 0° is shown. The symbol coordinate system is displayed as a part of each of the different symbol views to illustrate the orientation of the symbol coordinate system with respect to the viewing plane. The symbol coordinate system is not displayed in the actual rendering of the symbol views of the dynamic version of the symbol in the viewing plane. FIG. 7(a) depicts the original symbol view of the dynamic version of the symbol where the value of the rotation angle α is 0° and the value of the rotation angle β is 0°. When the value of the rotation angle α is 0° and the value of the rotation angle β is 0°, the symbol coordinate system is in the initial orientation position with respect to the viewing plane.

FIG. 7(b) depicts a symbol view of the dynamic version of the symbol where the value of the rotation angle α is 0° and the value of the rotation angle β is 22.5°. FIG. 7(c) depicts a symbol view of the dynamic version of the symbol where the value of the rotation angle α is 0° and the value of the rotation angle β is 30°. FIG. 7(d) depicts a symbol view of the dynamic version of the symbol where the value of the rotation angle α is 0° and the value of the rotation angle β is 60°. FIG. 7(e) depicts a symbol view of the dynamic version of the symbol where the value of the rotation angle α is 0° and the value of the rotation angle β is 67.5°. FIG. 7(f) depicts a symbol view of the dynamic version of the symbol where the value of the rotation angle α is 0° and the value of the rotation angle β is 90°.

Another example of methods and systems for generating dynamic representations or dynamic versions of a symbol including one or more dynamic noise components may be found in U.S. patent application Ser. No. 11/697,293 entitled “METHODS AND SYSTEMS FOR GENERATING A SYMBOL IDENTIFICATION CHALLENGE” listing Jason Koziol as the inventor. The patent application is hereby incorporated by reference herein.

For example in one disclosed method of generating a dynamic version of a symbol using a dynamic noise component a symbol image format is defined for each symbol in a associated image field. The image field is divided into a plurality of image blocks. An image of the symbol is defined in the image field using a first subset of the plurality of image blocks and a background is defined in the image field using a second subset of image blocks. A color tone is randomly generated for each of the individual image blocks that have been used to define the image of the symbol. Each color tone is randomly generated from a first range of color tones. A color tone is randomly generated for each of the individual image blocks that have been used to define the background thereby generating a color tone symbol image. Each color tone is randomly generated from a second range of color tones. The second range of color tones is either relatively lighter or relatively darker than the first range of color tones. A base challenge image is generated by applying a randomly generated color tone offset to the color tone symbol image using a color tone function.

In one embodiment, a plurality of secondary challenge images and the color tone symbol image are generated by applying a number of different color tone offsets to the base challenge symbol image using a color tone function. The base challenge image, the plurality of secondary challenge images and the color tone symbol image are organized in a slide show format.

In one embodiment, a plurality of color tone offsets is generated. Each color tone offset is applied as the color tone offset is generated to the challenge image using the color tone function and the associated image is displayed. Depending on the color tone offset used, the associated image is a secondary challenge symbol, the color tone symbol image or a “negative” version of the color tone symbol image.

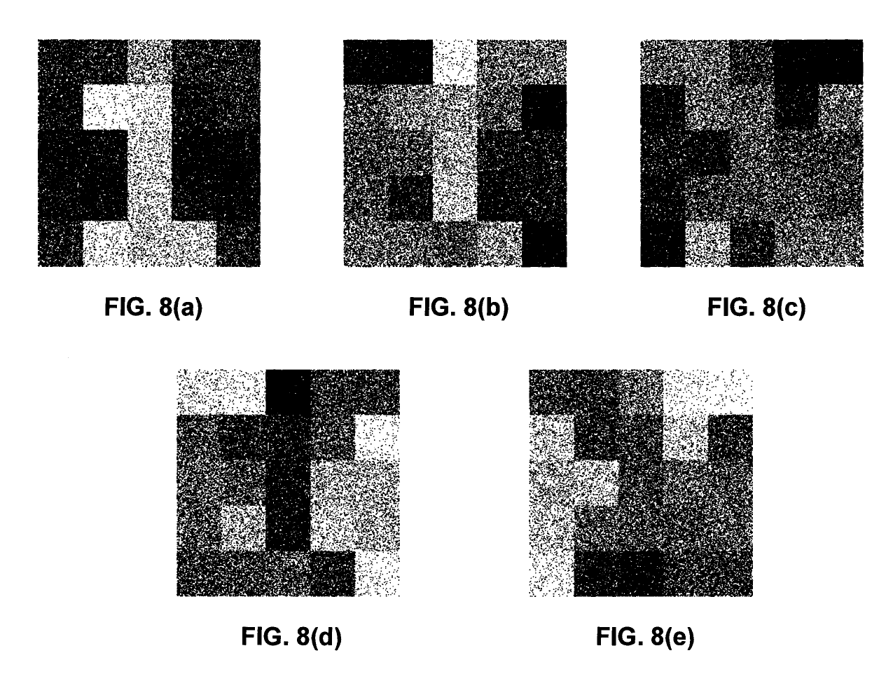

FIG. 8(a)-(e) are illustrations of a number of different symbol views of an example of a dynamic version of a symbol “1” with the application of different values a color tone offset using a color tone function

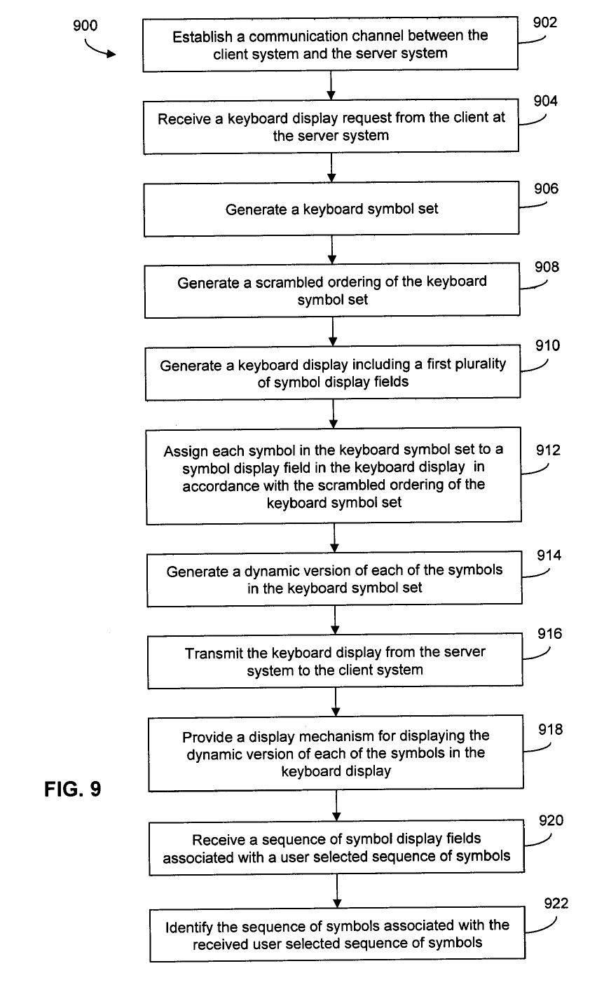

Referring to FIG. 9, a flowchart representation of one embodiment of a method 900 of communicating symbol data using a keyboard display that poses an identification challenge for an automated agent is shown. A communication channel is established between a client system 104 and a server system 102 at step 902. In one embodiment, the communication channel is established via a network infrastructure. In one embodiment, the communication channel is established via the Internet. In one embodiment, the communication channel is established responsive to a server system universal resource link (URL) address entered at the client system 104 via a web browser 316.

A keyboard display request is received from the client system 104 at the server system 102 at step 904. In one embodiment, the keyboard display request is a request for a keyboard display. In one embodiment, the keyboard request is a user validation request. In one embodiment, the server system 102 generates a server system web page for display at the client system 102 where the web page includes a field for entering a user identifier. In one embodiment, the keyboard display request consists of a submission a user identifier via the server system web page displayed at the client system 104.

The keyboard symbol generation module 410 receives the keyboard display request and responsively generates a keyboard symbol set at step 906. In one embodiment, the keyboard symbol generation module 410 retrieves a pre-defined keyboard symbol set from the symbol database 404. In one embodiment, the keyboard symbol generation module 410 retrieves one of a number of pre-defined keyboard symbols sets stored in the symbol database 404. In one embodiment, the keyboard symbol generation module 410 randomly selects one of the pre-defined keyboard symbols set.

In one embodiment, the keyboard symbol generation module 410 uses a received user identifier to retrieve a user specific sequence of symbols associated with the user identifier from the symbol database 404. The keyboard symbol generation module 410 retrieves an additional set of symbols from the symbol database 404. In one embodiment, the keyboard symbol generation module 410 randomly retrieves the symbols in the additional set of symbols from the available set of symbols stored in the symbol database 404. The keyboard symbol set generated by the keyboard symbol generation module 410 consists of the user specific symbols in the user specific sequence of symbols and the retrieved additional set of symbols.

The keyboard arrangement generation module 412 generates a scrambled ordering of the keyboard symbol set at step 908. The keyboard display arrangement module 412 receives the keyboard symbol set with the symbols being organized in an initial symbol order. In one embodiment, the keyboard display arrangement module 412 scrambles the initial symbol order by applying a scrambling application thereby generating a scrambled ordering of the keyboard symbol set. In one embodiment, the keyboard display arrangement creates a randomly generated ordering of the symbols in the keyboard symbol set thereby generating a scrambled ordering of the keyboard symbol set.

The keyboard arrangement generation module 412 generates a keyboard display including a first plurality of symbol display fields at step 910. The number of symbol display fields generated by the keyboard arrangement generation module 412 is equal to the number of symbols in the keyboard symbol set. The keyboard arrangement generation module 412 assigns each symbol in the keyboard symbol set to an associated symbol display field within the keyboard display in accordance with the scrambled ordering of the symbols in the keyboard symbol set at step 912.

The dynamic symbol generation module 414 generates a dynamic representation of each of the symbols in the keyboard display at step 914. The dynamic version of the symbols in the keyboard symbol set is displayed by a display mechanism in the keyboard display in accordance with the scrambled ordering of the keyboard symbol set.

In one embodiment, the dynamic symbol generation module 414 generates a symbol image set for each symbol in the keyboard symbol set. A display mechanism operates to display the symbol image set for each symbol in the keyboard display in a slide show format thereby displaying a dynamic version of each of the symbols. In one embodiment, the dynamic symbol generation module 414 generates a symbol image set for each symbol in the keyboard symbol set including multiple distorted versions of the symbol. In one embodiment, the dynamic symbol generation module 414 generates a symbol image set for each symbol in the keyboard symbol set including one or more distorted versions the symbol and one or more non-symbol images. In one embodiment, the dynamic symbol generation module 414 generates a symbol image set for each symbol in the keyboard symbol set including multiple different views of the symbol with a dynamic noise component where each different view of the symbol is generated by altering the value of the dynamic noise component of the associated symbol.

In one embodiment, the dynamic symbol generation module 414 generates a dynamic version of each symbol in the keyboard symbol set by incorporating a dynamic noise component. Altering the value of the dynamic noise component of the associated symbol generates a different view of the symbol. In one embodiment, a display mechanism interacts with the dynamic version of each of the symbols in the keyboard display by altering the value of the dynamic noise component and displaying an updated view of the symbol in the keyboard display on a real time basis at the client system 104. In one embodiment, the display mechanism randomly alters the value of the dynamic noise components.

The server system 102 transmits the keyboard display from the server system 102 to the client system 104 at step 916. The keyboard display with the dynamic version of each of the symbols in the keyboard symbol set arranged in accordance with the scrambled ordering of the keyboard symbol set is displayed at the client system 104.

The server system 102 provides the display mechanism that displays the dynamic version of each of the symbols in the keyboard display at step 918. In one embodiment, the server system 102 transmits the display mechanism that displays the dynamic version of the symbols in the keyboard display from the server system 102 to the client system 104. In one embodiment, the display mechanism remains at the server system 102 and interacts with the keyboard display at the client system 102 via a server system web page displayed at the client system 104.

A user selects a sequence of symbols from the keyboard display at the client system 104. In one embodiment, the server system 102 receives a sequence of symbol display fields associated with the sequence of selected symbols selected by the user from the keyboard display at the client system 104 at step 920. The symbol interpretation module 406 retrieves the stored associations between each of the symbols in the keyboard symbol set and the corresponding symbol display fields in the keyboard display and identifies the sequence of symbols associated with the sequence of symbol display fields received from the client system 104 at step 922. The identified sequence of symbols represents the sequence of symbols selected by the user from the keyboard display at the client system 104.

In one embodiment, the server system 102 performs a function of validating users at a client system as an authorized user. The user validation module 408 uses the user identifier submitted as a component of the keyboard display request to retrieve the user specific sequence of symbols associated with the received user identifier from the symbol database 404. The user validation module 408 compares sequence of symbols selected by the user at the client system 104 against the user specific sequence of symbols to determines whether there is a match. The user validation module 408 validates the user at the client system 104 as an authorized user if there is a match between the received sequence of symbols and the user specific sequence of symbols and denies validation of the user as an authorized user if the received sequence of symbols fails to match the user specific sequence of symbols.

While the steps in the method 900 have been described in a particular order, the steps may be performed in a different order. A subset of the described steps or steps in addition to those described may be performed.

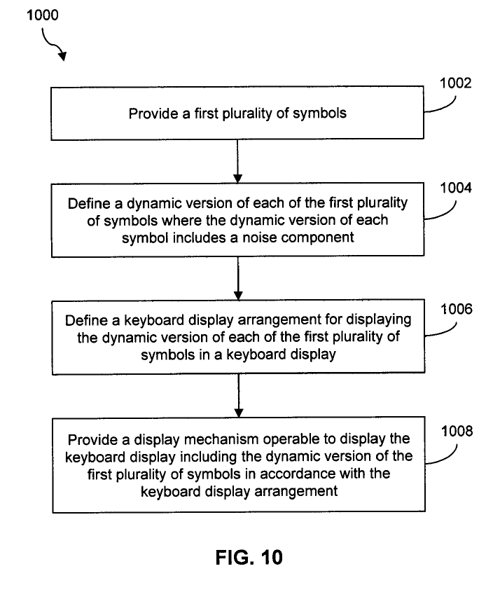

Referring to FIG. 10, a flowchart representation of one embodiment of a method of communicating symbol data using a keyboard display that poses an identification challenge for an automated agent is shown. A first plurality of symbols is provided at step 1002. A dynamic version of each of the first plurality of symbols is defined at step 1004. The dynamic version of each of the first plurality of symbols includes a noise component. A keyboard display arrangement is defined for displaying the dynamic version of each of the first plurality of symbols in a keyboard display at step 1006. A display mechanism operable to display the keyboard display including the dynamic version of the first plurality of symbols in accordance with the keyboard display arrangement is provided at step 1008. While the steps in the method 1000 have been described in a particular order, the steps may be performed in a different order or additional steps may be performed in addition to the described steps.

In one embodiment, a computer readable medium stores a computer executable program for communicating symbol data using a keyboard display that poses an identification challenge for an automated agent. The computer readable medium includes computer readable code for providing a first plurality of symbols, computer readable code for defining a dynamic version of each of the first plurality of symbols, the dynamic version of each of the first plurality of symbols including a noise component, computer readable code for defining a keyboard display arrangement for displaying the dynamic version of each of the first plurality of symbols in a keyboard display, and computer readable code for providing a display mechanism operable to display the keyboard display including the dynamic version of the first plurality of symbols in accordance with the keyboard display arrangement.

In one embodiment, a system 102 provides a keyboard display wherein the symbols selected from the keyboard display pose an identification challenge for an automated agent. The system 102 includes a keyboard symbol generation module 410, a dynamic symbol generation module 414, and a keyboard arrangement generation module 412. The keyboard symbol generation module 410 is operable to provide a first plurality of symbols. The dynamic symbol generation module 414 is operable to define a dynamic version of each of the first plurality of symbols. The dynamic version of each of the first plurality of symbols includes a noise component. The keyboard arrangement generation module 412 is operable to define a keyboard display arrangement for displaying the dynamic version of each of the first plurality of symbols in a keyboard display and to provide a display mechanism operable to display the keyboard display including the dynamic version of the first plurality of symbols in accordance with the keyboard display arrangement.

It should be noted that while systems implemented using software or firmware executed by hardware have been described above, those having ordinary skill in the art will readily recognize that the disclosed systems could be implemented exclusively in hardware through the use of one or more custom circuits, such as for example, application-specific integrated circuits (ASICs) or any other suitable combination of hardware and/or software.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of communicating symbol data using a keyboard display that poses an identification challenge for an automated agent, the method comprising:
providing a first plurality of symbols;
defining a dynamic version of each of the first plurality of symbols, the dynamic version of each of the first plurality of symbols including a noise component;
defining a keyboard display arrangement for displaying the dynamic version of each of the first plurality of symbols in a keyboard display; and
providing a display mechanism operable to display the keyboard display including the dynamic version of the first plurality of symbols in accordance with the keyboard display arrangement.

2. The method of claim 1, further comprising:
transmitting the display mechanism and the dynamic version of each of the first plurality of symbols to a destination system for display at the destination system; and
receiving a sequential selection of symbols selected via the keyboard display from the destination system.

3. The method of claim 2, wherein providing a first plurality of symbols comprises providing a first plurality of symbols including a first set of user specific symbols, the first set of user specific symbols having a user specific symbol sequence.

4. The method of claim 3, wherein providing a first plurality of symbols comprises providing a randomly generated second set of symbols, the first plurality of symbols including the first and second set of symbols.

5. The method of claim 3, further comprising:
determining whether the sequential selection of symbols received from the destination system matches the user specific symbol sequence; and
transmitting a user validation to the destination system based on the determination.

6. The method of claim 1, wherein defining a dynamic version of each of the first plurality of symbols comprises:
defining a symbol image for a first symbol, the first symbol being a first one of the first plurality of symbols;
defining at least one non-symbol image for the first symbol, the display mechanism being operable to sequentially display the symbol image and each of the at least one non-symbol images for the first symbol in the keyboard display.

7. The method of claim 1, wherein defining a dynamic version of each of the first plurality of symbols comprises:
defining a first version of a first symbol, the first symbol being one of the first plurality of symbols; and
adding a dynamic noise component to the first version of the first symbol thereby generating the dynamic version of the first symbol whereby varying the value of the dynamic noise component operates to alter the view of the dynamic version of the first symbol.

8. The method of claim 1, wherein defining a keyboard display arrangement for displaying the dynamic version of each of the first plurality of symbols in a keyboard display comprises defining a scrambled arrangement of the first plurality of symbols for display in the keyboard display.

9. The method of claim 1, wherein defining a keyboard display arrangement for displaying the dynamic version of each of the first plurality of symbols in a keyboard display comprises defining a randomly generated arrangement of the first plurality of symbols for display in the keyboard display.

10. The method of claim 1, further comprising receiving a keyboard display request.

11. A computer readable medium for storing a computer executable program for communicating symbol data using a keyboard display that poses an identification challenge for an automated agent comprising:
computer readable code for providing a first plurality of symbols;
computer readable code for defining a dynamic version of each of the first plurality of symbols, the dynamic version of each of the first plurality of symbols including a noise component;
computer readable code for defining a keyboard display arrangement for displaying the dynamic version of each of the first plurality of symbols in a keyboard display; and
computer readable code for providing a display mechanism operable to display the keyboard display including the dynamic version of the first plurality of symbols in accordance with the keyboard display arrangement.

12. The computer readable medium of claim 11, further comprising:
computer readable code for transmitting the display mechanism and the dynamic version of each of the first plurality of symbols to a destination system for display at the destination system; and
computer readable code for receiving a sequential selection of symbols selected via the keyboard display from the destination system.

13. The computer readable medium of claim 12, wherein the computer readable code for providing a first plurality of symbols comprises computer readable code for providing a first plurality of symbols including a first set of user specific symbols, the first set of user specific symbols having a user specific symbol sequence.

14. The computer readable medium of claim 13, wherein the computer readable code for providing a first plurality of symbols comprises providing a randomly generated second set of symbols, the first plurality of symbols including the first and second set of symbols.

15. The computer readable medium of claim 13, further comprising:
computer readable code for determining whether the sequential selection of symbols received from the destination system matches the user specific symbol sequence; and
computer readable code for transmitting a user validation to the destination system based on the determination.

16. The computer readable medium of claim 11, wherein the computer readable code for defining a dynamic version of each of the first plurality of symbols comprises:
computer readable code for defining a symbol image for a first symbol, the first symbol being a first one of the first plurality of symbols;
computer readable code for defining at least one non-symbol image for the first symbol, the display mechanism being operable to sequentially display the symbol image and each of the at least one non-symbol images for the first symbol in the keyboard display.

17. The computer readable medium of claim 11, wherein defining a dynamic version of each of the first plurality of symbols comprises:
computer readable code for defining a first version of a first symbol, the first symbol being one of the first plurality of symbols; and
computer readable code for adding a dynamic noise component to the first version of the first symbol thereby generating the dynamic version of the first symbol whereby varying the value of the dynamic noise component operates to alter the view of the dynamic version of the first symbol.

18. The computer readable medium of claim 11, wherein the computer readable code for defining a keyboard display arrangement for displaying the dynamic version of each of the first plurality of symbols in a keyboard display comprises computer readable code for defining a scrambled arrangement of the first plurality of symbols for display in the keyboard display.

19. The computer readable medium of claim 11, wherein the computer readable code for defining a keyboard display arrangement for displaying the dynamic version of each of the first plurality of symbols in a keyboard display comprises computer readable code for defining a randomly generated arrangement of the first plurality of symbols for display in the keyboard display.

20. The computer readable medium of claim 11, further comprising computer readable code for receiving a keyboard display request.

21. A system for communicating symbol data using a keyboard display that poses an identification challenge for an automated agent, the system comprising:
a display set definition module operable to provide a first plurality of symbols;
a dynamic symbol definition module operable to define a dynamic version of each of the first plurality of symbols, the dynamic version of each of the first plurality of symbols including a noise component; and
a display definition module operable to define a keyboard display arrangement for displaying the dynamic version of each of the first plurality of symbols in a keyboard display and to provide a display mechanism operable to display the keyboard display including the dynamic version of the first plurality of symbols in accordance with the keyboard display arrangement.
